(19) United States
(12) Patent Application Publication
(10) Pub. No.: US 2004/0027111 A1
(43) Pub. Date: Feb. 12, 2004

(54) Low-voltage power supply and triac switching circuitry

(76) Inventor: Wade Lee, Danville, CA (US)

Correspondence Address: ELLIOT B. ARONSON, 5001 HARBORD DRIVE, OAKLAND, CA, 94618

(21) Appl. No.: 10/462,027

(22) Filed: Jun. 14, 2003

Related U.S. Application Data
(60) Provisional application No. 60/388,978, filed on Jun. 14, 2002.

(51) Int. Cl. G05F 1/40

(52) U.S. Cl. 323/288

(57) ABSTRACT

A DC low-voltage power supply and triac switching circuit arrangement for use in electrical devices having low-voltage DC control circuitry and high-voltage AC switching. A circuit ground is defined with respect to the hot or live terminal of the AC power supply. A pair of capacitances is provided, one of which is charged to a low voltage level with respect to the circuit ground during a first half-cycle of the AC waveform and the other of which is charged to a low voltage level with respect to the circuit ground during the other AC half-cycle. The capacitances are arranged in the circuit in such a way that their charge levels are substantially maintained during the counter half-cycles. The capacitances are compounded and applied to an output network to provide a stable DC low-voltage output. A triac is fired by switching the triac gate to the circuit ground in response to a trigger signal from low-voltage control circuitry. A ground-shifting network is provided to shift the circuit ground with respect to the hot terminal so as to maintain the triac gate in triac firing relation with the zero crossing of the AC high-voltage waveform when the gate is connected to the circuit ground.

This application claims the benefit of provisional application No. 60/388,978 filed Jun. 14, 2002.

### BACKGROUND OF THE INVENTION

The present invention relates generally to electrical devices, such as motion-activated lighting, connected to a high-voltage power supply, for example the AC power mains, and having low-voltage control circuitry, such as a motion detector, for triggering the high-voltage supply, for example to turn on a light. The invention is more particularly directed to circuit arrangements for providing a low-voltage DC power supply for the control circuitry and arrangements for firing a triac to switch the high-voltage AC power supply across a load.

A number of consumer and industrial electrical devices need to be connected to the AC power mains, nominally at 120V in the United States, to operate, yet include control circuitry operating at a much lower DC voltage typically in the range of 3 to 12 Volts. A number of circuit arrangements are known for providing the low-voltage DC supply. Such electrical devices often include a triac for switching in the AC power in response to the low-voltage control circuitry. Triacs generally require specialized firing circuits. Specialized integrated circuit chips have even been developed for firing them. In a number of devices cost and size are considerations. Many known circuit arrangements are undesirable for such devices because they use too many components or they are too costly or they are too bulky.

### SUMMARY OF THE INVENTION

The present invention provides a convenient and cost effective DC low-voltage power supply and triac switching circuit arrangement for use in electrical devices of the type described above involving low voltage DC control circuitry and high-voltage AC switching.

It is an advantage of the invention that it may be configured with a comparatively small number of components of comparatively low cost. It is another advantage of the invention that it does not require specialized integrated circuit chips.

The invention provides a circuit arrangement and method of operating such circuit for achieving the above results.

Briefly, the invention operates by defining a circuit ground with respect to the hot or live terminal of the AC power supply. A pair of capacitances is provided, one of which is charged to a low voltage level with respect to the circuit ground during a first half-cycle of the AC waveform and the other of which is charged to a low voltage level with respect to the circuit ground during the other AC half-cycle. The capacitances are arranged in the circuit in such a way that their charge levels are substantially maintained during the counter half-cycles. The capacitances are compounded and applied to an output network to provide a stable DC low-voltage output.

With this circuit arrangement a triac is fired by switching the triac gate to the circuit ground in response to a trigger signal from low-voltage control circuitry. A ground-shifting network is provided to shift the circuit ground with respect to the hot terminal so as to maintain the triac gate in triac firing relation with the zero crossing of the AC high-voltage waveform when the gate is connected to the circuit ground.

Other aspects, advantages, and novel features of the invention are described below or will be readily apparent to those skilled in the art from the following specifications and drawings of illustrative embodiments.

### BRIEF DESCRIPTION OF THE DRAWINGS

FIG. 1 is an electronic schematic diagram of a power supply and triac firing circuit embodiment for practicing the invention.

FIG. 2 is a graphical representation of various waveforms illustrating operation of the power supply circuit of FIG. 1.

### DETAILED DESCRIPTION OF ILLUSTRATIVE EMBODIMENTS

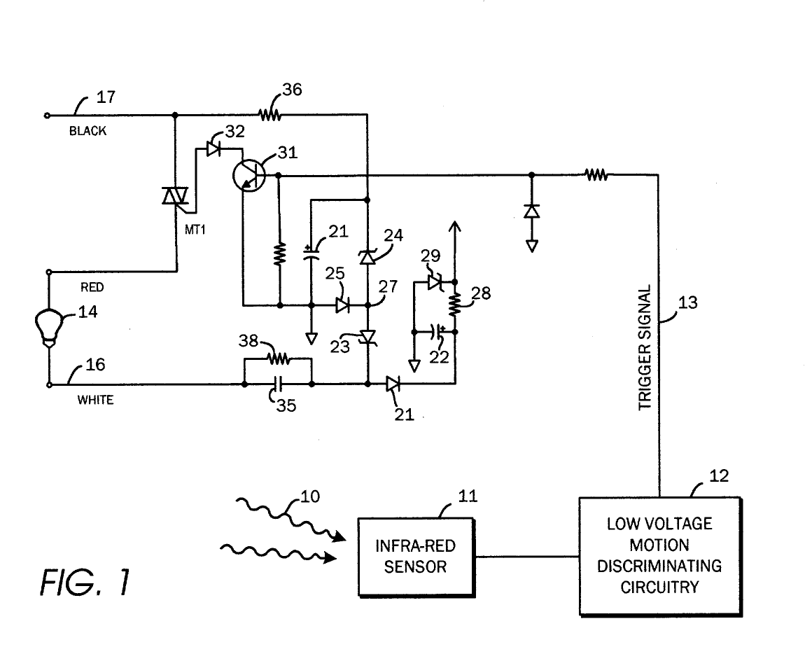

FIG. 1 illustrates a circuit embodiment according the invention in a passive infra-red motion detector. By way of background on motion detectors, infra-red energy 10 from a monitored field of view impinges upon an infra-red sensor 11, which provides an output signal characteristic of the incident infra-red energy. Motion-discriminating circuitry 12 receives the sensor output signal and determines whether the incident infra-red energy is characteristic of a moving target such as a person moving about in the field of view. If discrimination circuitry 12 detects motion, it provides a trigger signal along line 13 for energizing a light 14. The light fixture with motion detector is typically mounted on a wall, post or other structure and electrically connected to the AC power mains at the normal household voltage of 120V. In FIG. 1 the leads 16 and 17 are connected to the power mains. Lead 16, labeled White, is the normally neutral lead and lead 17, labeled Black, is the normally hot or live lead.

The motion-activated light fixture illustrates a common situation. The light 14 requires a comparatively high voltage (120V) to be energized at its normal operating level. But the light is energized in response to a control signal—here the trigger signal along line 13—which is provided by control circuitry operating at a comparatively low voltage typically in the range of 3 to 12V. The high voltage level is commonly switched in by a triac, shown in FIG. 1 at reference numeral 18, which allows sufficient current to flow to light 14 at the 120V voltage level in response to a low-voltage gating signal from the control circuitry. The invention provides a convenient circuit arrangement for firing triac 18 and for providing a low-voltage supply derived from the power mains for powering the low-voltage control circuitry. While an embodiment of circuitry is illustrated here in the example of a motion-activated light fixture, it will be readily apparent that the same or comparable circuitry can also be applied in other areas involving low-voltage control circuitry for controlling high-voltage devices such as other forms of controlled lighting, motors, or the like. Thus, the invention is not intended to be limited only to the motion detector illustrated here.

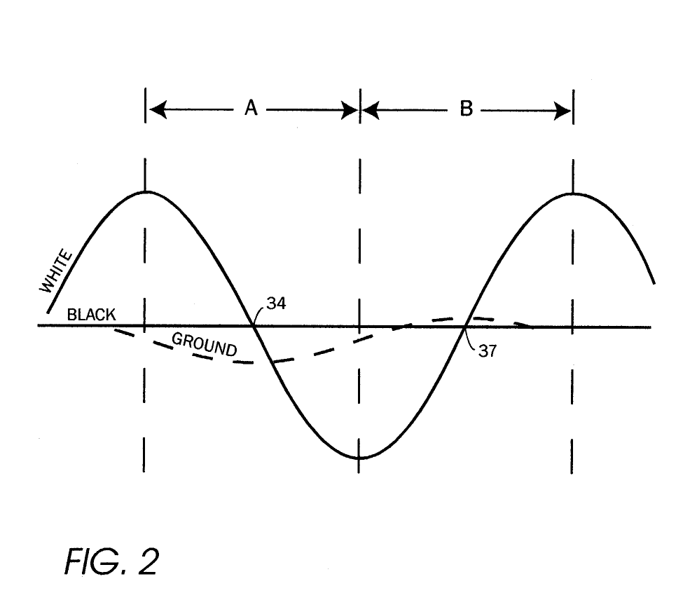

Attention is directed first to the low-voltage power supply. Power from the AC power mains is applied to the White and Black leads 16 and 17. To understand the operation of the circuit, it is beneficial to view the circuit voltages with respect to the Black, hot lead. FIG. 2 shows the AC waveform (solid line) on the White lead 16 with the Black (hot) lead 17 taken as the reference and the corresponding waveform at the circuit ground (dashed line) with respect to the Black lead 17. To generate a low-voltage supply for powering the low-voltage control circuitry, one-half of the AC voltage cycle is used to charge a first capacitor 21 and the other half of the AC voltage cycle is used to charge a second capacitor 22. Capacitor 21 is charged during the falling portion of the waveform on the White lead, indicated at half-cycle A in FIG. 2, and capacitor 22 is charged during the rising portion of this waveform, indicated at half-cycle B in FIG. 2. Back-to-back Zener diodes 23 and 24 are connected across the White and Black leads for pinning the charge on capacitors 21 and 22, which are isolated from the Zener diodes 22 during the appropriate half-cycles by diodes 25 and 26.

During the falling portion of the White waveform (half-cycle A), current flows from the Black lead to the White lead. Zener diode 24 is reverse biased and pinned at 6.8V and capacitor 21 charges to roughly that level. Capacitor 21 charges quickly and maintains its charge throughout the A half-cycle of the waveform. During the B half-cycle of the waveform current flows from the White lead to the Black lead. Zener diode 23 is reverse biased, and the voltage across it rises to 6.8V above that at node 27. At this point there is a potential of about 6V sitting at node 27 from capacitor 21 and another 6.8V at top of Zener diode 23 relative to ground. This forces the high end of diode 26 to get up to about 12V, which is applied to charge capacitor 22. The voltage at the top of capacitor 22 is divided down through resistor 28 and applied to Zener diode 29, which is pegged at 6.8V to provide a constant output voltage. This provides a stable low-voltage DC power supply for the rest of the low-voltage circuitry.

The firing of triac 18 will now be described. Triac 18 is fired by switching transistor 31. The triac is to be fired whenever a triggering High on line 13 from the low-voltage control circuitry is applied to transistor 31 switching it into its conducting state. To fire the triac, it is necessary to pull current out of the triac gate through diode 32 to the circuit ground. This is easily accomplished when the voltage on the White lead is larger than that on the Black lead by pulling current out of the triac main terminal 1 (MT 1) since the circuit ground is nearly at the Black lead voltage level. When the triac current goes through zero, the triac turns itself off and needs to be re-fired. The White and Black waveforms cross at crossing point 34 indicated in FIG. 2. As the White waveform passes through crossing point 34, there is almost no voltage across the triac and the White waveform is just starting to grow more negative. At this point if the circuit ground is at a lower potential than crossing point 34, then current can be pulled out of the triac to re-fire it.

To maintain the circuit ground below Black at crossing point 34, capacitor 35 and ground-shifting resistor 36 are introduced. Capacitor 35 effectively produces a 90-degree phase shift of current with respect to voltage. The phase shift effectively limits the power dissipated in circuit since the voltage drop across the capacitor is out of phase with the current. In FIG. 2 the current through capacitor 35 is zero at roughly the peak of the White waveform and is at its maximum around the crossing point 34 (in half-cycle A). Resistor 36 offsets the ground level with respect to the Black lead. In half-cycle A it causes the circuit ground to drop relative to the Black lead since current is flowing from Black to White during this phase, and thus the triac may be re-fired as the waveforms traverse crossing point 34. In half-cycle B the difference between the Black lead and ground at crossing point 37 will be smaller, and in fact the ground level may be pushed somewhat above the Black lead as shown in the example illustrated in FIG. 2. As the value of ground-shifting resistor 36 is increased, it becomes easier to fire the triac at crossing point 34, but firing gets delayed at the corresponding crossing point 37 in the B half-cycle of FIG. 2. Nevertheless, the size of the delay is small so as to have negligible observable effect on the brightness with which light 14 is illuminated. An appropriate value for ground-shifting resistor 36 will depend of course on the particular circuit components used in any given implementation. Those skilled in the electronics of triacs will be able to determine a suitable value in any given implementation to maintain light 14 at substantially full brightness when motion is detected.

Resistor 38 across capacitor 35 is a discharge resistor for quickly dissipating the charge built up on capacitor 35, which may be charged to a level close to the hot lead, in the event that the leads 16 and 17 should be disconnected from the power mains.

The above descriptions and drawings are given to illustrate and provide examples of various aspects of the invention in various embodiments. It is not intended to limit the invention only to these examples and illustrations. Given the benefit of the above disclosure, those skilled in the art may be able to devise various modifications and alternate constructions that although differing from the examples disclosed herein nevertheless enjoy the benefits of the invention and fall within the scope of the invention. For example, although the capacitors and resistors shown in FIG. 1 are symbolically indicated to be individual components, and in many applications this is desirable to keep the component count low, nevertheless other circuit configurations may be devised in which one or more of the components are provided by networks operative to provide the equivalent resistive or capacitive functions. It is not intended to exclude such configurations from the scope of the invention, which is to be defined by the following claims.

What is claimed is:

1. A circuitry arrangement for providing a low voltage DC power supply from a high voltage AC power source, said high voltage source having a hot power terminal and a neutral power terminal, and said circuit arrangement having a hot power lead and a neutral power lead adapted to be connected to said hot power terminal and neutral power terminal, comprising:
a first capacitance connected to said hot lead to be charged during a first half-cycle of said AC power source;
a first Zener diode connected to fix the voltage to which said first capacitance is charged;
a first diode connected to maintain said first capacitance in its charged state during a second half-cycle;
a second capacitance connected to said neutral lead to be charged during said second half-cycle of said AC power source;
a second Zener diode connected to fix the voltage to which said second capacitance is charged;
a second diode connected to maintain said second capacitance in its charged state during said first half-cycle; and
an output network connected across said second capacitance comprising an output Zener diode;
wherein said capacitances, Zener diodes, and diodes are operatively connected to provide a DC low-voltage supply level fixed by said output Zener diode with respect to a circuit ground defined at said Zener diode.

2. The circuit arrangement of claim 1, further comprising:
a triac for switching in a load across said neutral and hot leads;
a switching circuit operatively connected to switch the gate of said triac to said circuit ground in response to a trigger signal; and
a level-shifting network coupled to shift said circuit ground with respect to said hot power lead to control the firing times of said triac.
